(19) United States
(12) Patent Application Publication
(10) Pub. No.: US 2026/0255286 A1
(43) Pub. Date: Aug. 27, 2026

(54) METHODS AND APPARATUS FOR POWER CONTROL FOR SIDELINK POSITIONING

(71) Applicant: INTERDIGITAL PATENT HOLDINGS, INC., Wilmington, DE (US)

(72) Inventors: Tuong Hoang, Montreal (CA); Fumihiro Hasegawa, Westmount (CA); Tao Deng, New York, NY (US); Jaya Rao, Montreal (CA); Moon IL Lee, Melville, NY (US); Paul Marinier, Brossard (CA); Kunjan Shah, London (GB)

(73) Assignee: INTERDIGITAL PATENT HOLDINGS, INC., Wilmington, DE (US)

(21) Appl. No.: 19/102,320

(22) PCT Filed: Aug. 8, 2023
(86) PCT No.: PCT/US2023/029740

§ 371 Date: Feb. 7, 2025

Related U.S. Application Data
(60) Provisional application No. 63/396,056, filed on Aug. 8, 2022.
(60) Provisional application No. 63/445,533, filed on Feb. 14, 2023.

(51) Int. Cl. H04W 52/38; H04W 52/24

(52) U.S. Cl. CPC H04W 52/383; H04W 52/24

(57) ABSTRACT

A wireless transmit receive unit (WTRU) uses an open loop power control (OLPC) formula with sidelink (SL) or downlink (DL) pathloss parameters to transmit a first SL positioning reference signal (SL-PRS) and determines to apply a power offset as a function of the QoS of the positioning service for a second SL-PRS, QoS if a reference signal received power (RSRP) measured and transmitted by a peer WTRU in response to receiving the first SL-PRS is below a configured threshold RSRP associated with the QoS of the positioning service. Additional embodiments are disclosed.

### CROSS REFERENCE TO RELATED APPLICATIONS

This application claims priority benefit of U.S. Appln. Ser. No. 63/445,533, filed Feb. 14, 2023, and U.S. Appln. Ser. No. 63/396,056, filed Aug. 8, 2023, both of which are incorporated by reference as if fully set forth herein.

### BACKGROUND OF THE INVENTION

For sidelink (SL) positioning reference symbol (SL-PRS) transmission, to guarantee the QoS of the sidelink positioning service such as positioning accuracy, latency, reliability, SL reference signal received power (SL-RSRP) reception of the SL-PRS should be met (e.g., the SL-RSRP of a SL-PRS should be greater than a certain threshold). However, the transmission power of SL-PRS should also be limited to minimize the interference to other sidelinks and the radio access network (RAN) air interface (Uu).

For sidelink communication, open loop power control (OLPC) is supported. For all cast types, downlink (DL) pathloss is supported and for unicast SL pathloss is supported. The OLPC parameters (e.g., P0, alpha) may be (pre-)configured per resource pool. For sidelink positioning, it is expected that a minimum received power of SL-PRS should be guaranteed to satisfy the QoS (e.g., accuracy) requirement of the positioning service. Using the OLPC parameters (pre-)configured per pool may result in low reception power of SL-PRS, which may not satisfy the QoS requirement of the positioning service. There is an ongoing need for solutions on how to perform power control for SL-PRS to minimize interference to the system and satisfy the QoS (e.g., accuracy) of the positioning (POS) service.

### SUMMARY OF THE INVENTION

In some aspects, a user equipment (UE), also referenced interchangeably herein as a wireless transmit receive unit (WTRU), derives its transmission power using the OLPC formula for SL-PRS transmission. However, the WTRU may adjust its transmission power (e.g., increase by a delta_offset) if the SL-PRS measurement report indicates that the received power is not sufficient to guarantee the QoS of the positioning service. Upon reception of a SL-PRS measurement report, the WTRU determines whether to use a set of OLPC parameters only or additionally apply a delta_offset as a function of QoS of the positioning service to derive the Tx power its SL-PRS based on whether the reported SL-RSRP is greater than a (pre-)configured SL-RSRP threshold.

In another aspect, a WTRU determines which sidelink transmission (e.g., SL-PRS and/or data) to measure for SL reference signal received power (SL-RSRP) for OLPC based on the (pre-)configured type of resource pool to transmit a SL-PRS.

In a further aspect, a WTRU determines which SL pathloss to use to derive the Tx power for a SL-PRS based on the availability of each SL pathloss and a (pre-)configured priority/precedence of each pathloss.

In another aspect, a WTRU determines the transmission power of a SL-PRS based on the transmission power of a physical sidelink shared channel (PSSCH) and a (pre-)configured power boosting for a SL-PRS.

In a further aspect, for closed-loop power control (CLPC), the receiving (Rx) WTRU determines whether to include the received SL-PRS in its measurement report based on the SL-RSRP of the SL-PRS. If the received SL-RSRP is smaller than a threshold, the Rx WTRU feeds back a negative acknowledgement (NACK) (e.g., using a physical sidelink feedback channel (PSFCH)), to request additional SL-PRS transmissions from the Tx WTRU.

Example embodiments for a wireless transmit receive unit (WTRU) performing open loop power control are described herein. In one example a WTRU may determine whether to apply a power offset as a function of the QoS of the positioning service in an open loop power control (OLPC) formula for SL-PRS the reported SL-RSRP of the SL-PRS is smaller than a threshold. Specifically, the WTRU may perform the following procedure to determine SL-PRS. First, the WTRU may be preconfigured with the following OLPC power control parameters: SL and DL pathloss compensation (e.g. alpha and P0 for SL and DL); a received SL-RSRP threshold associated with the positioning service; and an offset in the OLPC formula as a function of QoS of the positioning service, referred to as a delta_offset. Next, the WTRU performs SL-PRS transmission at a first power using the (pre-)configured SL and DL pathloss compensation. Then, the WTRU receives sidelink positioning measurement reporting including (e.g., SL-RSRP) from Rx WTRU(s). Next, the WTRU may perform the following procedure for a new SL-PRS transmission, if the reported SL-RSRP is greater than the threshold, the WTRU uses the same SL and DL pathloss compensation parameters for transmission of a next SL-PRS. Otherwise, the WTRU increases the transmission power parameters by applying the offset based on the QoS of the positioning service in the formula. If the Tx power reaches its maximum, the WTRU may perform one or any of: changing the SL-PRS pattern (e.g., increase comb size); changing the resource pool; and/or inform another node (e.g., gNB or another WTRU).

In another example embodiment, a Tx WTRU performing closed loop power control (CLCP) is described herein. The Tx WTRU may perform CLPC for SL-PRS. The Tx WTRU may determine to adapt its SL-PRS transmission power based on the SL-RSRP threshold of the SL-PRS, the number of SL-PRS measurement resources, and the SL-PRS feedback from the receiver WTRUs. Specifically, the Tx WTRU may perform the following procedure to determine SL-PRS transmission power. First, a WTRU may be (pre-)configured with the following parameters: the received SL-RSRP threshold of SL-PRS and the number of SL-PRS measurement resources, which have received SL-RSRP being greater than the threshold, and an offset for each power adjustment step. Next, the WTRU performs a SL-PRS transmission and indicates the RSRP threshold to the Rx WTRU(s) (e.g., in the SCI associated with SL-PRS transmission) using an initial Tx power. Then the WTRU receives feedback regarding SL-PRS reception power from Rx WTRU(s). Next the WTRU performs the following for a new SL-PRS transmission: if the Rx WTRU(s) indicating the received SL-RSRP is smaller than the threshold, increases the Tx power using the (pre-)configured offset. Otherwise, uses the same Tx power for the new SL-PRS transmission. Finally, the WTRU performs SL-PRS transmission using the determined power.

An example embodiment for a Rx WTRU performing closed loop power control for SL-PRS is described. The Rx WTRU may determine whether to include the received SL-PRS to the measurement report based on the received SL-RSRP of the SL-PRS. In the case that the received SL-RSRP is smaller than a threshold, the Rx WTRU feedbacks the SL-PRS reception power to the Tx WTRU indicating the SL-RSRP is smaller than the threshold (e.g., one bit indication using the physical sidelink feedback channel (PSFCH)). Specifically, the Rx WTRU may perform the following procedure for CLPC for SL-PRS reception. A WTRU may be (Pre-)configured with the number of SL-PRS measurement resources, which have a received SL-RSRP being greater than a threshold. The WTRU receives a SL-PRS from the Tx WTRU having an RSRP threshold (e.g., an index in a RSRP threshold table) indicated in the associated sidelink control information (SCI). If the SL-RSRP measured on a received SL-PRS is smaller than the threshold, the Rx WTRU indicates to the Tx WTRU (e.g., one bit indication using PSFCH). Otherwise, the Rx WTRU includes the SL-PRS resources in the measurement report until the number of the measured of SL-PRS resources, which have a SL-RSRP greater than the SL-RSRP threshold, is greater than a specified threshold. Finally, the Rx WTRU performs a SL-PRS measurement report and transmits it to the Tx WTRU.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a signal timing diagram for sidelink positioning reference signals (SL-PRSs) according to an embodiment; and

FIG. 3 is a flow diagram detailing a method for adjusting transmission power of SL-PRSs according to an embodiment.

### DETAILED DESCRIPTION OF THE PREFERRED EMBODIMENTS

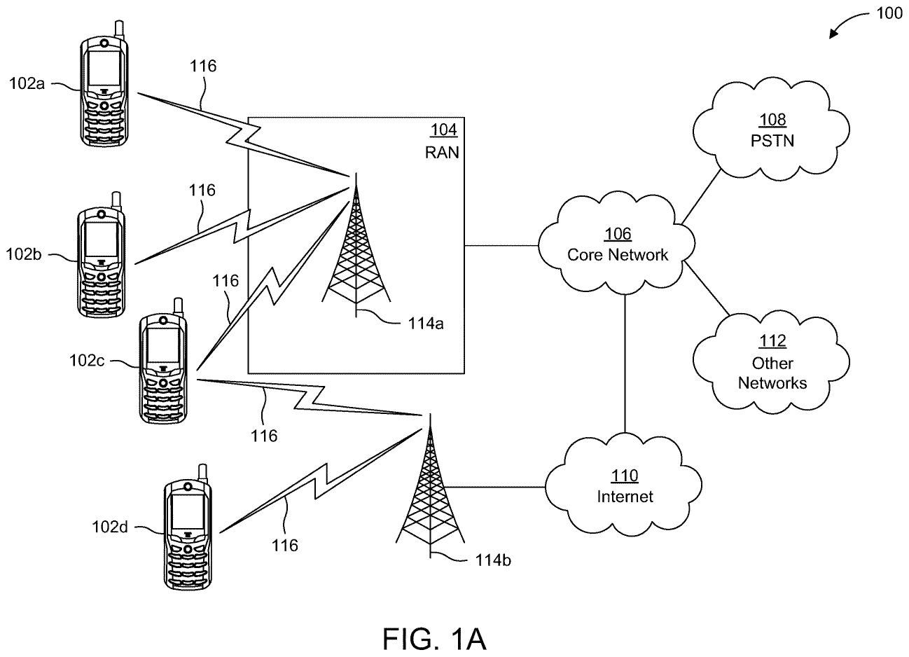

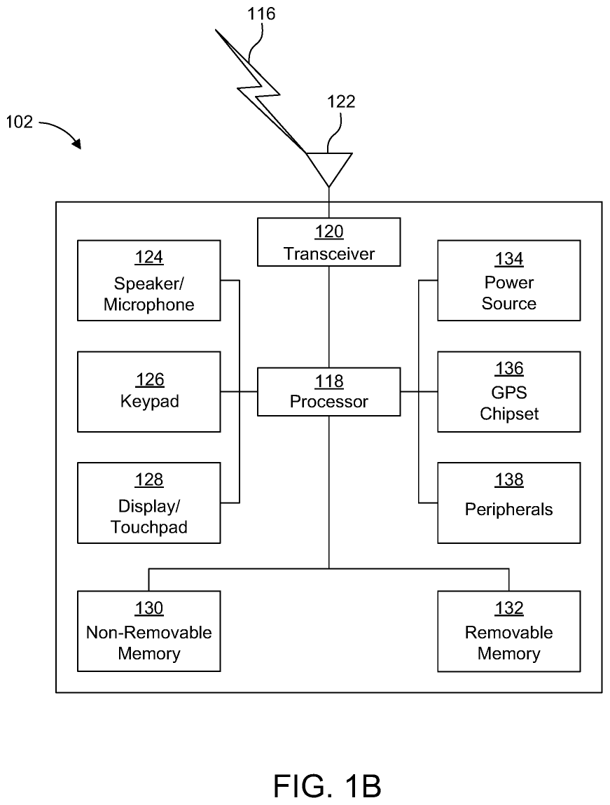

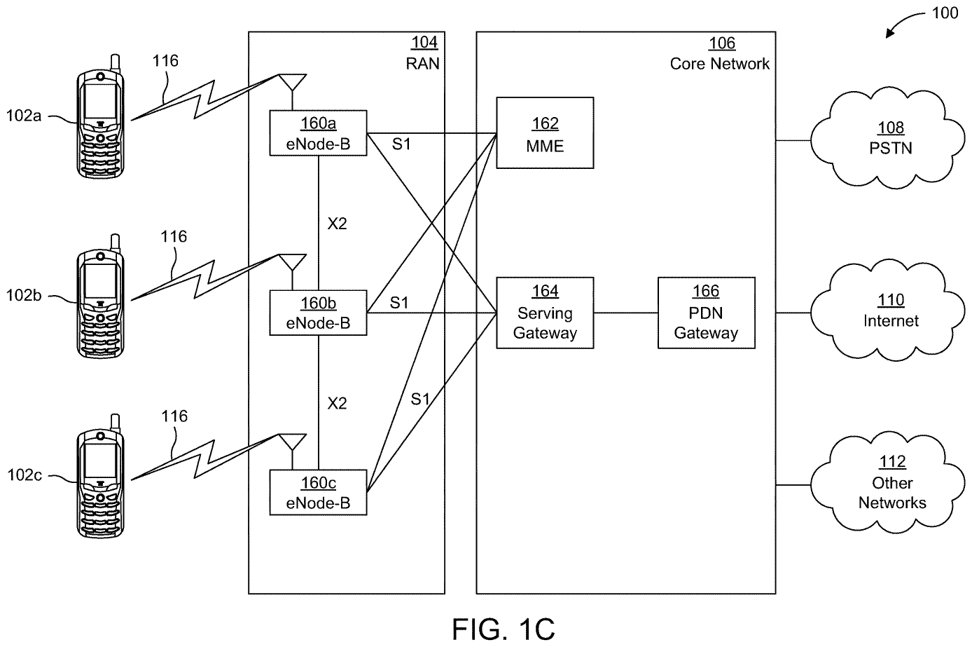

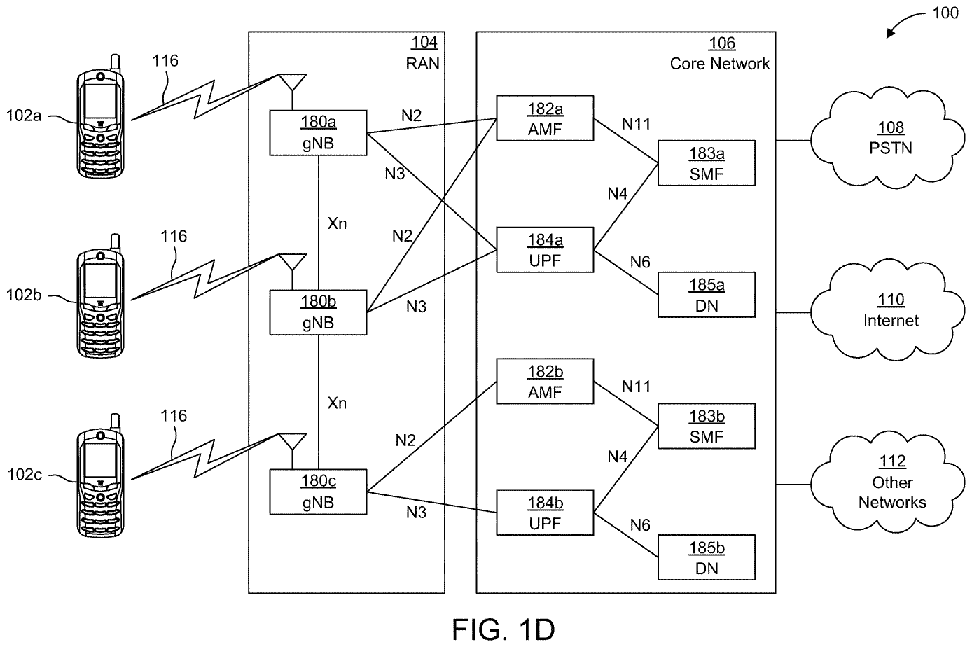

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP)services to one or more of the WTRUS 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHZ channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Wireless protocols have been specified to support sidelink (SL) transmissions, particularly between a vehicle and another receiver. This concept is referred to herein as vehicle-to-everything (V2X). In an example of V2X, the resources for sidelink transmission/reception are structured as resource pools. A resource pool may include a set of continuous frequency resources repeating in time following a bitmap pattern. A WTRU may be configured with one or multiple resource pools. For in coverage WTRUs, the resource pool can be configured via a system information block (SIB) or radio resource control (RRC) message. For out of coverage WTRUs, the resource pool can be (pre-)configured.

Each sidelink transmission may span within one slot including at least one of a physical sidelink shared channel (PSSCH) and a physical sidelink control channel (PSCCH). The PSSCH and PSCCH use frequency division multiplexing (FDM) and time division multiplexing (TDM). Sidelink control information (SCI) may be divided into two parts which are the first stage SCI and the second stage SCI. The first stage SCIs indicate the resources used for sidelink transmission, the QoS of the transmission (e.g., priority), demodulation reference signal (DMRS), phase tracking reference signal (PTRS) used for the sidelink transmission and the second SCI format. The second stage SCI may indicate the remaining control information. SCI can be used to reserve the resource for future transmissions within a resource pool.

From a sidelink scheduling perspective, the sidelink resource may be scheduled by the RAN network (i.e., Mode 1) or autonomously selected by the WTRU (i.e., Mode 2). If the WTRU performs Mode 2 scheduling, it may perform sensing by decoding SCI from other WTRUs before selecting the sidelink resources in order to avoid selecting the resources reserved by other WTRUs.

Sidelink channel state information reference signal (SL-CSI-RS) may be supported for unicast to support the Tx WTRU in determination of Tx parameters (e.g., power and rank). The Tx WTRU may indicate the presence of SL-CSI-RS by using SCI. CSI-RS transmission will trigger CSI reporting and CSI reporting latency may be configured via PC5 RRC. Each reporting may be associated with one SL-CSI-RS transmission.

In V2X, OLPC is supported, in which the WTRU can derive its transmission power based on the DL and/or SL pathloss. Specifically, for groupcast/broadcast, only DL pathloss is supported for OLPC. In general, DL pathloss is used to protect Uu transmission. For unicast, both the DL and SL pathloss can be used to derive the transmission power of the WTRU. The minimum power obtained from a DL pathloss and SL pathloss equation can be used for transmissions. To derive SL pathloss, the Rx WTRU performs L3-SL-RSRP measurement (in the DMRS of PSSCH) and reports the measurement to the Tx WTRU via a PC5 RRC.

Uu positioning may include specified DL-based, UL-based, and DL+UL-based positioning methods. In the DL-based positioning method, DL-PRSs are sent from multiple transmit receive points (TRPs) to the WTRU. The WTRU will observe and measure downlink signals from the TRPs. For the WTRU-B method, the WTRU may calculate its position and for WTRU-A method, the WTRU may return the downlink measurement to the network. For an Angle-based method, the WTRU may report the angle of arrival (AoA) and RSRP of the downlink signals from the TRPs. For a timing-based method, the WTRU may report the received signal time difference (RSTD). The above methods require the transmission timing synchronization among the TRPs. Positioning calculation errors using these methods mostly results from synchronization error and multipath reflection.

In uplink positioning methods, the WTRU sends an UL-PRS for positioning, configured by RRC, to the TRP. The network may then calculate the position of the WTRU based on the coordination of all the TRPs receiving UL-PRS from the WTRU.

In the UL and DL-based methods, the WTRU measures Rx-Tx time difference between received DL-PRS and transmitted UL-PRS. The Rx-Tx time difference and RSRP are reported to the network which may then coordinate the TRPs to calculate the position of the WTRU.

Example sidelink channels for power control are described herein. The power control parameters or methods described herein may be applicable for any sidelink physical channels including but not limited to SL-PRS, PSSCH, PSCCH, PSFCH, sidelink synchronization signal block (S-SSB), and physical sidelink broadcast channel (PSBCH). A transmission power of a sidelink may be a transmission power of a sidelink channel described above or a transmission power of a sidelink reference signal (e.g., SL-PRS, DM-RS of PSSCH, DM-RS of PSCCH, CSI-RS, PTRS). Hereafter, QoS parameter may be interchangeably used as QoS, a QoS parameter, one or more QoS parameters, at least one QoS parameter, one or any combination of the QoS parameters.

A WTRU may use one or any of the following reference signals as an SL-PRS: DMRS of PSSCH and/or PSCCH; Sidelink Synchronization Signal (SLSS) (S-PSS, S-SSS); PTRS; Sidelink Channel State Information Reference symbol (SL-CSI-RS); Physical Sidelink Feedback Channel (PSFCH); and/or any new reference signals designed for positioning purposes.

In an example a WTRU may determine the QoS of a positioning service. For example, the WTRU may determine the QoS of the positioning service. The QoS of the positioning service may be used to determine one or more of priority, accuracy, the latency, the reliability, the minimum communication range (MCR), and/or the positioning availability requirements of the positioning service. The QoS of the positioning service may be determined based on one or any combination of the following: (Pre-)configured in the resource pool and/or the WTRU; one or more parameters of SL-PRS transmission and/or reception; SL-PRS reception requirements; Implicit/explicit Indication from another node; one or more parameters of the DL-PRS reception and/or UL-PRS transmission (pre-)configured or conveyed to the WTRU; one or more parameters of SL-PRS measurement report; one or more parameters for DL-PRS measurement report and/or a positioning method.

The QoS positioning may be determined using (pre-)configurations in the resource pool and/or the WTRU. For example, in a shared resource pool between SL-PRS and sidelink data communication, the WTRU may be (pre-)configured with a priority associated with SL-PRS transmission. The WTRU may then indicate the (pre-)configured priority of the sidelink positioning service in one or more transmissions associated with the SL-PRS transmission.

QoS positioning may be determined using one or more parameters of SL-PRS transmission and/or reception. For example, the WTRU may determine the QoS of the positioning service (e.g., accuracy/priority) based on the bandwidth of the SL-PRS. Specifically, the WTRU may be (pre-)configured with one or more QoS levels of the positioning service, in which each QoS level may be associated with one bandwidth of SL-PRS. The WTRU may then determine the QoS of the positioning service based on the bandwidth of SL-PRS transmission/reception.

For example, the QoS positioning may be determined using SL-PRS reception requirements (e.g., the minimum received SL-RSRP, the maximum reception timing error). For example, the WTRU may determine the one or more QoS of the positioning service (e.g., accuracy/priority) based on the SL-RSRP reception requirement of SL-PRS. Specifically, the WTRU may be (pre-)configured with one or more QoS levels of the positioning service, in which each QoS level may be associated with one SL-RSRP reception level of SL PRS. The WTRU may then determine the QoS of the positioning service based on the required SL-PRSP level of SL PRS.

In some embodiments, the QoS positioning may be determined using implicit/explicit indication from another node (e.g., another WTRU or gNB). For example, the WTRU may implicitly/explicitly receive one or more QoS parameters of the positioning service from another WTRU or gNB. The WTRU may receive one or more QoS parameters based on the reception of the SL-PRS configuration (e.g., priority, bandwidth, comb size, number of repetitions, periodicity), SL-PRS measurement report configuration (e.g., priority, periodicity, latency).

In other embodiments, the QoS positioning may be determined using one or more parameters of the DL-PRS reception and/or UL-PRS transmission (pre-)configured or conveyed to the WTRU. For example, for hybrid sidelink and Uu positioning, the WTRU may determine the QoS of the positioning service (e.g., accuracy/priority) based on the bandwidth of the UL-PRS and/or DL-PRS. Specifically, the WTRU may be (pre-)configured one or more QoS levels of the positioning service, in which each QoS level may be associated with one bandwidth of UL-PRS and/or DL-PRS. The WTRU may then determine the QoS of the positioning service based on the bandwidth of SL-PRS transmission/reception.

In one example, the QoS positioning may be determined using one or more parameters of SL-PRS measurement report (e.g., priority, latency, periodicity). In another example, the QoS positioning may be determined using one or more parameters for DL-PRS measurement report (e.g., priority, latency, periodicity). In a further example, the QoS positioning may be determined using a positioning method. For example, the WTRU may be (pre-)configured with one or more QoS parameters associated with the positioning method. For example, the WTRU may be (pre-)configured a priority associated with each positioning method.

In embodiments for methods for open-loop power control, in one example, the WTRU may be preconfigured with one or a combination of parameters for performing power control, such as open-loop power control. In an example, the WTRU may be (pre)configured with one or any combination of the following parameters. The WTRU may be (pre)configured with P_{C,MAX}, which may indicate the maximum transmission power in a carrier c. For example, the WTRU may be (pre)configured with P_{C,MAX,CBR}, which may indicate the maximum transmission power in a carrier c as a function of the channel busy ratio (CBR) of the resource pool. In one example, the WTRU may be (pre)configured with P_{C,MAX,QoS}, which may indicate the maximum transmission power per one QoS of the positioning service. In one example, the WTRU may be (pre)configured with P_{C,MAX,MCR}, which may indicate the maximum transmission power per one communication range between the transmission and receiver. In an example, the WTRU may be (pre)configured with P_{C,MAX,UEclass}, Which may indicate the maximum transmission power for one WTRU class. In another example, the WTRU may be (pre)configured with P_{o,,QoS}, which may indicate the nominal transmission power (e.g., target received power) for OLPC. The nominal transmission power may be (pre-)configured with different values for sidelink pathloss, downlink pathloss, for unicast, groupcast, and broadcast. It may also be configured as a function of the QoS of the positioning service.

In another example, the WTRU may be (pre)configured with α_{QoS}, which may indicate the scaling factor for pathloss compensation in OLPC. The scaling factor may be (pre-)configured different values for sidelink pathloss, downlink pathloss, for unicast, groupcast, and broadcast. The scaling factor may be a (pre-)configured as a function of the QoS of the positioning service. In an example, the WTRU may be (pre)configured with PL_{SL}, which may indicate the sidelink pathloss. The WTRU may be (pre)configured with PL_{DL}, which may indicate the downlink pathloss. In one example, the WTRU may be (pre)configured with M_{PSSCH}, which may indicate the number of resource elements (REs)/physical resource blocks (PRBs) used for data communication. The WTRU may be (pre)configured with M_{PSCCH}, which may indicate the number of REs/PRBs used for the control channel. In one example, the WTRU may be (pre)configured with M_{SL-PRS}, which may indicate the number of REs/PBRs used for a SL-PRS. In one example, the WTRU may be (pre)configured with Δ_{QoS}, which may indicate the power offset for a QoS level of the sidelink positioning service, which may be (pre-)configured different values for unicast, groupcast, and broadcast. In one example the WTRU may be (pre)configured with Δ_{SL-PRS pattern}, which may indicate the power offset for each SL-PRS pattern. The WTRU may also determine its transmission power based on a function of one or any combination of the OLPC parameters.

In another example the WTRU may determine the transmission power scheme. For example, the WTRU may determine which power control scheme to use (e.g., which set of power control parameters and the value associated with each parameter to use in Tx power calculation, whether to use OLPC or CLPC, whether to use fixed power or variable power, etc.) based on one or any combination of the following: cast type associated with the positioning service; the number of WTRUs in the positioning group for groupcast-based sidelink positioning; SL-PRS multiplexing scheme with other transmission; whether SL-PRS reception indication/reporting is enabled/disabled; and/or an indication from another node.

In an example, the WTRU may determine which power control scheme to use based on cast type associated with the positioning service. For example, the WTRU may use power offset for QoS (Δ_{QoS}) for groupcast. However, the WTRU may not use Δ_{QoS} for unicast. For example, the WTRU may use SL pathloss for unicast and it may not use SL pathloss for other casts (e.g., broadcast/groupcast).

In one example, the WTRU may determine which power control scheme to use based on the number of WTRUs in the positioning group for groupcast-based sidelink positioning. For example, the WTRU may use SL pathloss in the OLPC formula if the number of WTRUs in the sidelink positioning group is smaller than a threshold; otherwise, the WTRU may not use the SL pathloss.

In another example, the WTRU may determine which power control scheme to use based on SL-PRS multiplexing scheme with other transmission. For example, the WTRU may use the SL pathloss for OLPC if the SL-PRS is multiplexed with another transmission (e.g., another SL-PRS). Otherwise, the WTRU may not use the SL pathloss in the OLPC formula (e.g., the WTRU may use the maximum transmission power).

In another example, the WTRU may determine which power control scheme to use based on whether SL-PRS reception indication/reporting is enabled/disabled. For example, the WTRU may be (pre-)configured with two OLPC formulas, in which one formula may be used for OLPC when the feedback of SL-PRS reception power is enabled, and another formula may be used for OLPC when the feedback of SL-PRS reception power is disabled.

In an example, the WTRU may determine which power control scheme to use based on indication from another node (e.g., another WTRU or gNB). For example, the WTRU may receive an indication from another node (e.g., another WTRU or gNB) to use a certain OLPC formula. For example, the WTRU may receive an indication from another node to use a certain set of OLPC parameters (e.g., Δ_{QoS}). The WTRU may then use the indicated parameters to determine its transmission power.

In another example, a WTRU may determine which power control scheme to use based on transmission parameters for a SL-PRS. For example, the WTRU may determine the power control scheme based on SL-PRS configuration (e.g., frequency range, repetition factor) and/or positioning method (e.g., SL-AoA, round trip time (RTT), received signal time difference (RSTD)). Configurations for transmission parameters for SL-PRS may contain at least one of the following parameters: number of symbols, transmission power, number of PRS resources included in SL-PRS resource set, muting pattern for SL-PRS (for example, the muting pattern may be expressed via a bitmap), periodicity, type of SL-PRS (e.g., periodic, semi-persistent, or aperiodic), slot offset for periodic transmission for PRS, vertical shift of SL-PRS pattern in the frequency domain, time gap during repetition, repetition factor, RE (resource element) offset, comb pattern, comb size, spatial relation, QCL information (e.g., QCL target, QCL source) for SL-PRS, number of TRPs/anchor WTRUs, Absolute Radio-Frequency Channel Number (ARFCN), subcarrier spacing, expected RSTD, uncertainty in expected RSTD, start Physical Resource Block (PRB), bandwidth, BWP ID, number of frequency layers, start/end time for SL-PRS transmission, on/off indicator for PRS, TRP ID, PRS ID, cell ID, global cell ID, and applicable time window. The WTRU may apply a PRS configuration under a condition that the current time is within the applicable time window.

In various embodiments, a WTRU may adapt its transmission power. Specifically, the WTRU may perform one or any combination of the following parameters or schemes regarding power adaptation.

In one example the WTRU may adapt its transmission power based on an increase/decrease its transmission power by an offset (e.g., Δ_{QoS}). The WTRU may additionally or alternatively adapt its transmission power by applying a different function of OLPC formula (e.g., using different set of values for nominal transmission power P_{o,,QoS}, and scaling factor α_{QoS}). The WTRU may alternatively or additionally adapt its transmission power by adding an offset to the OLPC formula or the WTRU may adapt its transmission power by removing an offset from the OLPC formula.

In one example the WTRU may adapt its transmission power by changing the transmission power scheme. In one approach, the WTRU may change the set of power control parameters in the OLPC formula. In another approach, the WTRU may change the value of one or more OLPC parameters.

In various embodiments the WTRU may adapt its transmission power by performing power adaptation based on one or any combination of the following triggering events: (i) receiving an implicit or explicit indication from another node to increase or decrease transmission power; (ii) receiving a measurement report from another WTRU, (iii) not receiving a measurement report or indication from another WTRU; (iv) experiencing a chance in coverage status; (v) changing an RRC state; (vi) enabling or disabling the SL-PRS reception indication; (vii) a CBR is greater or smaller than a threshold; (viii) the WTRU changes the SL-PRS transmission multiplexing with other transmission; or (ix) when the number of SL-PRS transmissions in a period is greater or smaller than a threshold.

In one example a WTRU may perform power adaption when the WTRU receives an implicit/explicit indication from another node to increase/decrease transmission power.

In another example a WTRU may perform power adaption when the WTRU receives the measurement reporting from another WTRU, which may implicitly/explicitly indicate that the reception power is smaller/larger than a threshold. For example, the WTRU may receive SL-PRS measurement reporting from the Rx WTRU(s). In one approach, if the measured SL-RSRP is smaller than a threshold, the WTRU may increase its transmission power by Δ_{QoS}, which may be a function of the QoS of the positioning service. Otherwise, if the measured SL-RSRP is larger than the threshold, the WTRU may keep the same transmission power (e.g., the WTRU may not apply the power offset Δ_{QoS} in the OLPC formula). The SL-RSRP threshold may be (pre-)configured as a function of the QoS of the positioning service.

In another approach, the WTRU may further determine whether to use an offset □_QoS based on the CBR of the resource pool. Specifically, if CBR of the resource pool is smaller than a threshold, the WTRU may use an offset Δ_{QoS}; otherwise, if the CBR of the resource pool is larger than a threshold, the WTRU may not use the offset Δ_{QoS}. This approach may be motivated to reduce the congestion level of the resource pool.

In one example, a WTRU may perform power adaption when the WTRU does not receive the measurement report and/or indication from another WTRU. For example, the WTRU may not receive SL-PRS measurement reporting from the Rx WTRU(s). The WTRU may increase its transmission power by Δ_{QoS}, which may be a function of the QoS of the positioning service. The SL-RSRP threshold may be (pre-)configured as a function of the QoS of the positioning service. The WTRU may further determine whether to use the power offset as a function of QoS (Δ_{QoS}) based on CBR of the resource pool. Specifically, if CBR of the resource pool is smaller than a threshold, the WTRU may apply the power offset Δ_{QoS}. Otherwise, the WTRU may not apply the power offset Δ_{QoS}.

In another example, a WTRU may perform power adaption when the WTRU changes its coverage status (e.g., the WTRU changes from InC to OoC or it changes for OoC to InC). In another example a WTRU may perform power adaption when the WTRU changes its RRC state (e.g., the WTRU changes from RRC connected to Idle/Inactive or from Idle/Inactive to connected). In further examples, a WTRU may perform power adaption when the WTRU enable/disable the SL-PRS reception/indication or when the CBR is greater/smaller than a threshold. A WTRU may perform power adaption when the WTRU changes the SL-PRS transmission multiplexing with other transmission (e.g., from another WTRU) or when the number of SL-PRS transmissions in a period is greater/smaller than a threshold.

In certain embodiments, the WTRU may determine transmission power of one channel based on the transmission of another channel. In one solution, the WTRU may be (pre-)configured with two different set of parameters for two different channels (e.g., PSCCH/PSSCH vs. SL-PRS). The WTRU may calculate the transmission of the two channels independently. However, the WTRU may adjust transmission power of one channel/signal based on the transmission power of another channel/signal.

In another example, the WTRU may adjust the transmission power of PSCCH/PSSCH based on the transmission power of SL-PRS. Specifically, the WTRU may adjust the transmission power of PSCCH/PSSCH by increasing or decreasing the PSCCH/PSSCH transmission power such that the Energy Per Resource Element (EPRE) gap between two channel is smaller than a threshold. The threshold may be fixed or (pre-)configured, which may be a function of the QoS of the positioning service.

As a further example, the WTRU may adjust the transmission power of SL-PRS based on the transmission power of PSCCH/PSSCH. Specifically, the WTRU may adjust the transmission power of SL-PRS by increasing or decreasing the SL-PRS transmission power such that the EPRE gap between two channel is smaller than the threshold. The threshold may be fixed or (pre-)configured, which may be a function of the QoS of the positioning service.

For additional embodiments, the WTRU may determine transmission power for SL-PRS based on whether the SL-PRS is multiplexed with data. For example, the WTRU may multiplex SL-PRS with sidelink data for SL-PRS transmission. The WTRU may determine the transmission power of SL-PRS and/or sidelink data based on one or combination of the following: (i) one or more power control parameters (pre-)configured for sidelink data communication; or (ii) one or more power control parameters (pre-)configured for SL-PRS transmission.

In one solution, the WTRU may determine the transmission power of SL-PRS based on one or more power control parameters (pre-)configured for sidelink data communication. Specifically, the WTRU may determine the transmission power of SL-PRS based on the transmission power of sidelink data. The WTRU may perform power boosting for SL-PRS (e.g., increasing transmission power for SL-PRS). For example, the WTRU may first determine the transmission power of sidelink data. The WTRU may then boost transmission power of SL-PRS X dB compared to sidelink data communication.

In another solution, the WTRU may determine the transmission power of SL-PRS based on the one or more power control parameters of both SL-PRS and sidelink data communication. Specifically, in the OLPC formula to determine its transmission power, the WTRU may use one or more transmission power parameters of SL-PRS and one or more transmission power parameters for sidelink data.

In another example, the WTRU may multiplex SL-PRS with sidelink data for SL-PRS transmission. The WTRU may determine the transmission power of SL-PRS and/or sidelink data based on one or any combination of power control parameters (pre-)configured for sidelink data communication and power control parameters (pre-)configured for SL-PRS transmission. In one solution, the WTRU may determine the transmission power of SL-PRS based on one or more power control parameters (pre-)configured for sidelink data communication. Specifically, the WTRU may determine the transmission power of SL-PRS based on the transmission power of sidelink data. The WTRU may perform power boosting for SL-PRS (e.g., increasing transmission power for SL-PRS). For example, the WTRU may first determine the transmission power of sidelink data. The WTRU may then boost transmission power of SL-PRS X dB compared to sidelink data communication. In another solution, the WTRU may determine the transmission power of SL-PRS based on the one or more power control parameters of both SL-PRS and sidelink data communication. Specifically, in the OLPC formula to determine its transmission power, the WTRU may use one or more transmission power parameters of SL-PRS and one or more transmission power parameters for sidelink data.

In other embodiments a WTRU may determine its transmission power based on the reception power of the peer WTRU. In one solution, the WTRU may determine its transmission power (e.g., of SL-PRS) based on the reception power (e.g., of SL-PRS) from the peer WTRU. Specifically, the WTRU may determine the value of the nominal transmission power (e.g., target received power Pₒ) for OLPC based on the received power from the peer WTRU. This approach may be motivated to support the RTT positioning method, in which the SL-PRS transmission and reception power may be similar to achieve the best positioning accuracy.

In another example, the WTRU may receive SL-PRS from the peer WTRU during a positioning session. The WTRU may transmit SL-PRS to the peer WTRU. In another example, the peer WTRU may be one of the WTRUs in a group formed for a positioning purpose (e.g., to perform SL-TDOA, SL-AoA, SL-AoD). In one example, a peer WTRU may have location management function (LMF) functionality.

In a further example, the WTRU may determine a pathloss RS via configuration by the network/peer WTRU (e.g., the peer WTRU indicates the index of SL-PRS resource to be used as the pathloss RS). Using the pathloss RS, the WTRU may determine the pathloss or determine transmission power based on the pathloss measurement. In another example, the WTRU may make measurements on the pathloss RS and report the measurements to the network/peer WTRU/WTRU which transmitted the pathloss RS.

In certain cases, the WTRU may determine to initiate OLPC if at least one of the following conditions is satisfied: (1) the WTRU is configured, by the network (e.g., gNB, LMF) or target/anchor/peer WTRU, to perform OLPC before SL-PRS transmission, the WTRU receives a request from peer WTRU/network to perform OLPC; (2) a change in measurement (e.g., a change in measurement (e.g., RSRP, RSRPP) of the pathloss RS is above a preconfigured threshold, where the change is between the last occasion of the measurement of the pathloss RS and current occasion of the measurement); or (3) using a positioning method (e.g., the WTRU may initiate OLPC if RTT-based positioning method is configured).

According to some embodiments, the WTRU may determine a sidelink pathloss. In one solution, the WTRU may determine the SL pathloss to use for the OLPC formula. The WTRU may determine the SL pathloss based on the measurement report from the peer WTRU during the discovery procedure. Specifically, the WTRU may calculate the SL pathloss based on the received power of the worst WTRUs in the sidelink positioning group. The WTRU may receive the measurement reporting of the received power during the discovery procedure to select the set of WTRUs in sidelink positioning group.

In another example, the WTRU may determine the SL pathloss for OLPC based on the sidelink positioning measurement reporting (e.g., SL-RSRP measurement reporting) from the peer WTRUs. Specifically, the WTRU may receive SL-RSRP measurement on the SL-PRS transmission. The WTRU may then determine the SL pathloss based on the reported SL-RSRP measurement. In one approach, the WTRU may use the smallest reported SL-RSRP to derive the SL pathloss for SL-PRS transmission. The WTRU may use the maximum allowable transmission power if it does not receive one or more SL-RSRP measurement from one or more WTRUs. The WTRU may use the maximum allowable transmission power if one or more reported SL-RSRP from one or more WTRUs is smaller than a (pre-)configured threshold.

In another example, the WTRU may determine the SL pathloss based on the measurement report of the reference WTRU/TRP. The WTRU may determine the reference WTRU according to the configuration from the network/peer WTRU (e.g., the reference WTRU may be indicated in the configuration). If the WTRU performs a group-based positioning method (e.g., SL-TDOA, SL-AoA), the WTRU may determine the reference WTRU in the group. The WTRU may transmit the pathloss RS (e.g., SL-PRS) to the reference WTRU. The WTRU may determine the SL pathloss based on the measurement report from the reference WTRU. In one example, the WTRU may determine the pathloss from the SL RS (e.g., SL-PRS, pathloss RS) transmitted from the reference WTRU. The WTRU may receive configuration information (e.g., via unicast/groupcast/broadcast) about which RS from the reference WTRU to monitor or reference WTRU ID for pathloss determination.

In another example, the WTRU may determine the reference WTRU/RS for pathloss determination based on at least one of the following conditions:

(i) the WTRU receives an indication/configuration from the network/WTRU about the reference WTRU or reference RS for pathloss determination; (ii) the measurement (e.g., SL-RSRP) for the reference RS is above/below the threshold; (iii) channel condition (e.g., LOS indicator) is above the threshold; and (iv) positioning method: For example, for RTT, the WTRU may determine that the peer WTRU is the reference WTRU. In another example, for SL-TDOA, the WTRU may determine the reference WTRU based on configuration/indication from the network/peer WTRU/WTRU which initiated the positioning session/WTRU with the LMF capability.

According to various embodiment, the WTRU may determine the transmission power before having SL pathloss and/or DL pathloss information. In one approach, the WTRU may use DL pathloss in the OLPC formula when SL pathloss is not available. In another approach, the WTRU may use the maximum allowable transmission power when SL pathloss is not available. In another approach, the WTRU may use a (pre-)configured default transmission power when SL pathloss is not available.

For embodiments where the WTRU determines the transmission power scheme based on the positioning method, in one solution, a WTRU (e.g., anchor WTRU) may determine which power control scheme to use (e.g., which set of power control parameters and the value associated with each parameter) based on one or any combination of positioning methods. For example, the WTRU may use OLPC for timing-based positioning methods such as RTT, SL-TDOA. The WTRU may use fixed transmission power for angle-based positioning methods such as AOD.

In some embodiments the WTRU may request another WTRU to report SL-RSP for its transmission. In one solution, a WTRU (e.g., target WTRU) may request another WTRU (e.g., anchor WTRU in a unicast link) to perform SL-RSRP measurement and report the measurement. The WTRU may request which type of sidelink transmission can be used to measure SL-RSRP, which may include one or any combination of sidelink data transmission, SL-PRS transmission, or both sidelink data and SL-PRS transmissions.

Based on the reported SL-RSRP from the peer WTRU (e.g., the receiver of the request), the WTRU may then derive the SL pathloss in the unicast link between two WTRUs. As used herein “SL pathloss derived from sidelink data” may describe the case that SL pathloss is derived from a SL-RSRP measured from sidelink data transmission, and “SL pathloss derived from SL-PRS” may describe the case that SL pathloss is derived from a SL-RSRP measured in a SL-PRS. The SL pathloss derived from SL-RSRP measured in both SL-PRS and sidelink data is equivalent to the SL pathloss derived from SL-PRS and sidelink data transmission.

In one example, the WTRU may determine to use the SL pathloss derived from sidelink data for SL-PRS based on at least one of the following conditions:
The WTRU receives an indication from the network/peer WTRU to use the same pathloss between sidelink data and SL-PRS. The use of same pathloss herein may imply that the WTRU measures same pathloss RS for sidelink communication and sidelink positioning.
The WTRU may determine to use the same pathloss if time and/or frequency resources from the shared resource pool are granted for SL-PRS transmission while the resources for SL data communication are granted from the same shared resource pool.
The SL-PRS is associated with SL RS (e.g., DMRS, CSI-RS) for data communication. Examples of the association may be spatial relationship (or in spatial QCL relationship), transmission from the same panel, same group (e.g., timing error group, phase error group). For example, if the SL-PRS and DMRS in a SL channel are spatially related (e.g., they are transmitted in the same direction), the WTRU may determine to use the same power applied to the DMRS to the SL-PRS.
The Rx WTRU is the same for SL data communication and SL positioning. For example, the WTRU transmits SL-PRS or sidelink data to the same WTRU.

In one example, the WTRU may determine the pathloss separately from data communication if a different resource pool (e.g., a resource pool dedicated for positioning) from data communication resource pool is used for positioning. In this case, the WTRU determines a pathloss for SL positioning and another pathloss for SL data transmission. Two resource pools may be different if their time and/or frequency resources do not overlap.

A WTRU (e.g., target WTRU) may request from the peer WTRU (e.g., anchor WTRU) which type of SL transmission to measure SL-RSRP based on the availability of SL-PRS configuration and/or SL-PRS resources. For example, the WTRU may request the peer WTRU to measure SL-RSRP based on the sidelink communication if it doesn't have SL-PRS configuration and/or SL-PRS resources are not available. Alternatively, the WTRU may request the peer WTRU to measure SL-RSRP based on SL-PRS if SL-PRS configuration and/or SL-PRS resources are available.

A WTRU (e.g., target WTRU) may request from the peer WTRU (e.g., anchor WTRU) which type of SL transmission to measure SL-RSRP based the type of resource pool (pre-)configured for SL-PRS transmission. For example, if SL-PRS is (pre-)configured to transmit in a shared resource pool, the WTRU may request the peer WTRU to measure SL-RSRP in both SL-PRS and sidelink data transmissions.

In one solution, the Rx WTRU may determine which sidelink transmissions to measure SL-RSRP based on one or any combination of: indication from the Tx WTRU; the availability of SL-PRS configuration and/or SL PRS transmissions; the frequency of SL-PRS transmission; and the type of resource pool.

With respect to the availability of SL-PRS configuration and/or SL-PRS transmissions, the WTRU may measure SL-RSRP in sidelink data transmission if SL-PRS configuration and/or SL-PRS transmission is not available. The WTRU may measure SL-RSRP in SL-PRS transmission if SL-PRS is available.

With respect to the frequency of SL-PRS transmission, the WTRU may measure SL-RSRP in SL-PRS if the number of SL-PRS resources within the measurement window is greater than a threshold. Otherwise, the WTRU may measure SL-RSRP using sidelink data communication.

With respect to the type of resource pool (pre-)configured for SL-PRS transmission, If SL-PRS is (pre-)configured to transmit in a shared resource pool, the WTRU may measure SL-RSRP using SL-PRS and/or sidelink data transmission. In one example, the WTRU may measure SL-RSRP using SL-PRS only. In another example, the WTRU may measure SL-RSRP using sidelink data transmission only. In yet another example, the WTRU may measure SL-RSRP using both sidelink data transmission and SL-PRS transmission.

For example, if SL-PRS is (pre-)configured to transmit in a dedicated resource pool, the WTRU may then measure each SL-RSRP individually. Specifically, the WTRU may measure SL-RSRP using SL-PRS in the dedicated resource pool for SL-PRS. The WTRU may measure SL-RSRP using sidelink data transmission using the sidelink data resource pool.

In another example, when SL-PRS is transmitted in a shared resource pool, the Rx WTRU may measure SL-RSRP in both SL-PRS and sidelink communication. The Rx WTRU may first determine whether the transmission is from the intended WTRU (e.g., using link ID, source ID, and/or destination ID indicated in the SCI) and then it filters these transmissions to derive the SL-RSRP. In another solution, the WTRU may measure SL-RSRP based on SL-PRS transmission. Specifically, the WTRU may first determine whether the transmission is from the intended WTRU (e.g., using link ID, source ID, and/or destination ID indicated in the SCI). The WTRU may then determine whether the transmission includes SL-PRS (e.g., based on the indication in the SCI). The WTRU may then filter these transmission having SL-PRS from the same WTRU to calculate SL-RSRP.

In another example, the Rx WTRU may determine which SL-RSRP to report to the Tx WTRU. In one solution, the WTRU may report SL-RSRP measured in SL-PRS if it is available; otherwise, it may report SL-RSRP measured in sidelink data transmission. In another solution, the WTRU may report both SL-RSRP measured in SL-PRS and SL-RSRP measured in sidelink data transmission.

In another example, a WTRU determines which SL pathloss to calculate its transmission power of SL-PRS. The WTRU (e.g., anchor WTRU) may determine which SL pathloss to use to calculate its transmission power of SL-PRS based on one or any combination of the following: a preconfigured or configured priority, the availability of each SL pathloss; or by determining a default SL pathloss references.

With respect to (pre-)configured and/or (pre-)defined priority, the WTRU may prioritize using SL pathloss derived from SL-PRS transmission when it is available.

With respect to the availability of each SL pathloss, the WTRU may always use SL pathloss derived from SL-PRS transmission if it is available. The WTRU may use SL pathloss derived from sidelink data transmission when the SL pathloss derived from SL-PRS is not available. Alternatively, the WTRU may use fixed transmission power if SL pathloss derived from SL-PRS is not available.

If the WTRU determines that the SL pathloss (e.g., SL pathloss reference signal) is not available, the WTRU may determine to use the default SL pathloss reference (e.g., DL RS) preset or configured by the network/peer WTRU (e.g., SSB).

In another approach, a WTRU (e.g., anchor WTRU) may determine to change its power control scheme (e.g., which set of power control parameters and the value associated with each parameter to use in Tx power calculation, whether to use OLPC or CLPC, whether to use fixed power or variable power, etc.) when one or both SL pathloss is not available. For example, if both SL and DL pathloss are (pre-)configured, the WTRU may use DL pathloss only for OLPC when one or both SL pathloss is not available. Alternatively, if SL pathloss is (pre-)configured for OLPC, the WTRU may use fixed transmission power when one or both of SL pathloss are not available. In one example, the WTRU may use fixed transmission power when SL pathloss derived from SL-PRS is not available. In another example, the WTRU may use fixed transmission power when both SL pathloss derived from SL-PRS and sidelink data is not available.

A WTRU (e.g., anchor WTRU) may determine which power control scheme to use (e.g., which set of power control parameters and the value associated with each parameter) for groupcast SL-PRS transmission based on one or any combination of the following: preconfigured, DL pathloss, the set of available SL pathloss from the group of WTRUs, QoS of the positioning service, the range of the positioning group.

With respect to the (Pre-)configured option, the WTRU may be (pre-)configured with a fixed transmission level for groupcast SL-PRS. The WTRU may then transmit the groupcast SL-PRS according to the (pre-)configured level.

With respect to DL pathloss, for groupcast SL-PRS transmission, the WTRU may use the DL pathloss to calculate the OLPC transmission power based on the DL pathloss only.

With respect to the set of available SL pathloss from the group of WTRUs, the WTRU may be (pre-)configured to use SL pathloss for OLPC. The WTRU may request one or more WTRUs to report a SL-RSRP to derive the SL pathloss. The WTRU may then determine the transmission power using the OLPC based on the function of the available SL pathlosses from the group of WTRUs. Specifically, the WTRU may use the lowest SL pathloss, largest SL pathloss, or average SL pathloss to derive transmission power from OLPC formula.

With respect to a QoS of the positioning service (e.g., positioning accuracy), the WTRU may be (pre-)configured with multiple levels of transmission powers for groupcast SL-PRSs. The WTRU may then determine which power level to transmit based on the positioning accuracy requirement.

With respect to the range of the positioning group, the WTRU may be (pre-)configured with its transmission power as a function of the positioning group range (e.g., the maximum distance between one SL-PRS transmitter and one SL-PRS receiver, e.g., maximum distance between the anchor WTRU and target WTRU). The WTRU may then determine its transmission power based on the range of the group.

A WTRU (e.g., anchor WTRU) may determine which power control scheme to use (e.g., which set of power control parameters and the value associated with each parameter) for broadcast SL-PRS transmission based on one or any combination of the following: preconfigured, DL pathloss, the set of available SL pathloss from the group of WTRUs, QoS of the positioning service, and the range of the positioning service.

With respect to the (Pre-)configured option, the WTRU may be (pre-)configured with a fixed transmission level for broadcast SL-PRSs. The WTRU may then transmit a broadcast SL-PRS according to the (pre-)configured level.

With respect to DL pathloss parameters, for a broadcast SL-PRS transmission, the WTRU may use the DL pathloss to calculate the OLPC transmission power based on the DL pathloss only.

With respect to QoS of the positioning service (e.g., positioning accuracy) parameters, the WTRU may be (pre)configured with multiple levels of transmission power levels for groupcast SL-PRSs. The WTRU may then determine which power level to transmit based on the positioning accuracy requirement. Specifically, the WTRU may use a low transmit power for a low accuracy requirement positioning service. By contrast, the WTRU may use a high transmit power for a high accuracy requirement positioning service. The QoS requirement of the positioning service may be indicated from another WTRU, from network (e.g., LMF, gNB), or selected by the WTRU itself.

With respect to the range of the positioning service, the WTRU (e.g., RSU) may be (pre-)configured a transmission power level as a function of its positioning service range. The WTRU may then determine which power level to transmit based on the range of the positioning service.

In one solution, a WTRU (e.g., anchor WTRU) may determine whether to use OLPC based on one or any combination of the following: the positioning method; the availability of SL or DL pathloss; RS pathloss; power used by a peer WTRU; measurements; or a received measurement report.

With respect to the positioning method, the WTRU may use OLPC for timing-based methods such as SL-TDOA and RTT. The WTRU may not use the OLPC for angle-based positioning methods such as AOD, AOA.

With respect to the availability of SL and/or DL pathloss option, if the WTRU is (pre-)configured to use both SL and DL pathloss, the WTRU may not use OLPC if SL and/or DL pathloss is not available. The WTRU may be (pre-)configured with a fixed transmission power when SL and/or DL pathloss is not available. For example, the WTRU may be (pre-)configured to use SL pathloss and in one approach, the WTRU may determine to use OLPC when SL pathloss is available. In another approach, the WTRU may determine to use OLPC when the SL pathloss measured in a SL-PRS is available. Otherwise, the WTRU may not use OLPC when SL pathloss measured in a SL-PRS is not available. Examples of availability of the pathloss are the following: the WTRU may be configured to use an RS (e.g., DL-RS, SL-RS) for the pathloss measurement. The WTRU may make measurements on the pathloss RS and the measurement (e.g., RSRP) may be below the threshold. In this case, the WTRU may determine that the pathloss RS Is not available. In another example, the WTRU may not receive pathloss measurements from peer WTRU/network.

In one example, the WTRU may determine power level for OLPC using the reference RS (e.g., pathloss reference RS) and apply the determined power level to the RS (e.g., power-target RS). The WTRU may determine to apply the power/power level (e.g., measured in watts, dB, dBm) determined for the power-target RS to an RS(s) that are associated with the power-target RS. The power level may be determined based on the reference power (e.g., transmission power used at a Tx panel for the WTRU). Examples of association among RS(s) is the following; one or more RSs are spatially associated (e.g., two RSs are transmitted toward the similar direction, e.g., within the range of AoD, or in QCL (Quasi co-located) relationship (e.g., two RSs experience similar Doppler frequency/shift, similar channel environment), one or more RSs are associated with the same resource set/TRP/PRS ID/frequency layer/group (e.g., timing error group, phase error group, a group in groupcast, group determined by the target WTRU), the power-target WTRU receives an indication from the network/WTRU to apply the power level to the indicated group/set/subset of RSs. In another example, the WTRU may determine to apply the same power/power level to the RSs associated with the power-target RS based on a positioning method. For example, if angle-based positioning method (e.g., SL-AoA) is used by the WTRU, the WTRU may determine to apply the same power/power level to the RSs associated with the power-target RS.

In one example embodiment, the WTRU may determine to use the power level/power used by peer WTRU. For example, if the WTRU is configured with an RTT-based positioning method (e.g., two WTRUs transmit a SL-PRS to each other to measure the round-trip time), one WTRU (e.g., anchor WTRU) may indicate its power level/power (e.g., determined from OLPC) to the peer WTRU (e.g., target WTRU). The target WTRU, for example, may receive the indication about power/power level from the anchor WTRU and use the power/power level to adjust its own transmission power.

In another example embodiment, the WTRU may determine to measure the pathloss RS and determine the pathloss based on the measurement or receive the measurement report from the peer WTRU and determine the pathloss based on the report. The WTRU may determine one of the aforementioned actions whether the WTRU is the first one to transmit/receive in a RTT positioning method (e.g., two WTRUs transmit SL-PRS to each other). For example, if the WTRU transmits a SL-PRS first, the WTRU may determine the pathloss based on the returned measurement report (e.g., RSRP for the transmitted SL-PRS, RSRP for the pathloss reference) from the peer WTRU. Alternatively, if the WTRU receives the SL-PRS first, the WTRU determines the pathloss based on the pathloss reference RS (e.g., SL-PRS). In another example, the WTRU performing the RTT positioning method may determine the pathloss based on the configured pathloss RS (e.g., SSB).

For various embodiments, the validity of power/power level determined by OLPC is now described. In one example, the WTRU may determine that a power/power level determined by OLPC is valid during a positioning session (e.g., a duration during which the WTRU performs positioning and ends when a termination requirement (e.g., the WTRU reports its location) is met).

In another example, the power/power level determined by OLPC may be considered valid if the power/power level is determined by concurrent SL data communication session (e.g., data communication session is running in parallel with the positioning session).

In some embodiments, the power/power level determined by the WTRU may be associated with a timer. For example, if the WTRU determines that a timer for a current power/power level expires, the WTRU may start/restart the OLPC procedure (e.g., determine power/power level based on pathloss RS).

If the WTRU determines to use the same pathloss for both SL data and SL-PRS transmission, the WTRU may determine validity based on criteria defined for either data communication or positioning. For example, if the pathloss associated with RS(s) used for positioning and SL data communication becomes invalid based on a criteria for data communication, the WTRU may determine that the pathloss is invalid for positioning.

In other example embodiments, the WTRU may determine whether to adjust its transmission power for congestion control. In one solution, a WTRU (e.g., anchor WTRU) may determine whether to adjust its transmission power for congestion control during a measurement gap and/or measurement window based on a positioning method. For example, the WTRU may adjust its transmission power for timing-based positioning methods such as SL-TDOA, RTT. The WTRU may fix its transmission power (e.g., apply the same transmission power to a group/subset of SL-PRSs) for angle-based positioning methods such as AoD, AoA and/or any positioning methods that require measurements of RSRP/RSRP per path.

In one solution, a WTRU (e.g., anchor WTRU) may determine whether to adjust its transmission power for congestion control during a measurement gap and/or measurement window based on whether the WTRU indicates its transmission power in the associated transmission with SL-PRS (e.g., in SCI). For example, the WTRU may adjust its transmission power for congestion control if it indicates its transmission power in the associated transmission with SL-PRS. Otherwise, if the WTRU does not indicate its transmission power in the associated transmission within SL-PRS, the WTRU may fix its transmission power for a measurement gap and/or a measurement window.

In one solution, a WTRU (e.g., anchor WTRU) may determine whether to stop OLPC. Specifically, the WTRU may fix its transmission power based on whether the WTRU reaches its maximum (pre-)configured transmission power.

The WTRU may also fix its transmission power based on whether the WTRU changes to another positioning method. For example, the WTRU may be indicated to change from a timing-based to an angle-based positioning method, the WTRU may then stop using its OLPC and may then use a fixed transmission power.

In yet another example, the WTRU may stop OLPC and the WTRU may determine to use the transmission power (e.g., measured in dB, watts, dBm) determined for the previous/last transmission occasion. Alternatively, the WTRU may determine to initiate OLPC for a different RS (e.g., do not use the RS where OLPC is not performed).

In another example, the WTRU may use the transmission power preconfigured by the network (e.g., gNB, LMF) or WTRU. The aforementioned transmission power may be a preset value at the WTRU.

In another example, the measurement (e.g., RSRP, AoA, AoD) of the pathloss reference RS (e.g., SL CSI RS, SSB, DL RS) is below or above the threshold, the WTRU determines to stop OLPC. In another example, quality indicator/range of the measurement (e.g., range of RSRP measurement, standard deviation/variance of RSRP measurement) for the pathloss reference RS is above/below the threshold, the WTRU determines to stop OLPC. For example, if the WTRU determines that the pathloss reference is not reliable (e.g., RSRP is below the threshold), the WTRU determines to stop OLPC. When the WTRU determines to stop OLPC, the WTRU may use the transmission power preconfigured by the network (e.g., gNB, LMF) or peer WTRU, or preset value at the WTRU.

In another example, the WTRU may determine that an OLPC time period expired, where the WTRU starts the timer when the WTRU starts OLPC. If the WTRU determines that the OLPC timer expired, the WTRU stops OLPC.

In another example, the WTRU may determine a time window associated with OLPC is passed. In one example, the WTRU may be configured with start time/end time/duration of the time window during which the WTRU may perform OLPC. The start/end time may be expressed in terms of absolute/relative time, symbol/slot/frame index and duration may be expressed in terms of number of symbols/slots/frames or seconds.

The WTRU may determine that a spatial relationship between the reference RS (e.g., DL/SL RS) and the RS to which OLPC is applied is not valid (e.g., spatial relationship). The WTRU may receive an indication from the network that the spatial relationship between the reference and RS to which OLPC is applied is not valid and the WTRU stops OLPC.

In some embodiments, the WTRU may determine to use a fixed transmission power. In one solution, a WTRU (e.g., anchor WTRU) may determine to fix its transmission power for a SL-PRS. The WTRU may then determine its transmission power based on one or any combination of the following: (Pre-)configured; QoS requirement of the positioning service, or an indication from another WTRU. For example, the WTRU may be (pre-)configured with multiple transmission levels, in which each transmission level may be associated with the QoS requirement (e.g., priority, latency, reliability, accuracy, positioning range) of the positioning service. For instance, the WTRU may use high transmission power for the positioning service with high accuracy requirement and/or use lower transmission power for the positioning service with a less stringent accuracy requirement. The WTRU may use high transmission power for a high positioning range requirement or alternatively, the WTRU may use low transmission power for low positioning range requirements. In another example, when the target WTRU may be the SL-PRS receiver, it may then indicate by signaling, the expected transmission power of the anchor WTRU.

A WTRU (e.g., anchor WTRU) may determine its fixed transmission power based on one or more parameters calculated/derived before the measurement gap and/or a measurement window. Specifically, the WTRU may derive DL pathloss, SL pathloss, and CBR before the measurement window and/or measurement gap. The WTRU may then calculate its transmission power for a SL-PRS using one or more of these parameters using the OLPC formula. The WTRU may then keep its transmission power during the measurement gap and/or measurement window. The WTRU may determine the measurement gap parameters via configurations from the network or peer WTRU.

In another example, a WTRU (e.g., anchor WTRU) may indicate its transmission power to the peer WTRU (e.g., target WTRU), which may be used to support the peer WTRU in determining the link quality between two WTRUs. In one approach, the WTRU may indicate its transmission power in each transmission associated with a SL-PRS (e.g., in SCI). In another approach, the WTRU may indicate its transmission power of a SL-PRS during a measurement window. The WTRU may implicitly/explicitly indicate the measurement gap and/or measurement window to the peer WTRU. The WTRU may then fix its transmission power/power level during the measurement gap and/or measurement window. The WTRU may then indicate its transmission power using, e.g., a MAC CE, PC5 RRC, and/or sidelink positioning protocol (SLPP).

In another example, a WTRU may (e.g., anchor WTRU) determine whether to indicate its transmission power to another WTRU (e.g., target WTRU) based on whether the WTRU is the receiver of the SL-PRS measurement. Specifically, the WTRU may indicate its transmission power to the peer WTRU if it is not the receiver of the a SL-PRS measurement report. Otherwise, if the WTRU is the receiver of the SL-PRS measurement report, the WTRU may not indicate its transmission power to the peer WTRU.

For another example, a WTRU (e.g., anchor WTRU) may indicate its transmission power to the network (e.g., LMF) to support the network in calculating the link between two WTRUs. In another approach, the WTRU may indicate its transmission power to the peer WTRU (e.g., target WTRU). The WTRU may determine whether to indicate its transmission power to the network (e.g., LMF) and/or another WTRU based on one or any combination of the following: whether the positioning method is WTRU assisted or WTRU based, or the coverage status of the WTRU.

For example, for WTRU-based positioning method, the WTRU may indicate the transmission power to the peer WTRU (e.g., target WTRU). For a WTRU-assisted positioning method, the WTRU may indicate its transmission power to the network (e.g., LMF).

In a case, if the WTRU is out of coverage, the WTRU may report its transmission power to the peer WTRU. The peer WTRU may then determine whether to report the indicated power to the network (e.g., LMF) based on whether it is performing a WTRU-assisted or a WTRU-based positioning method. Specifically, if the WTRU is performing a WTRU-assisted positioning method, the WTRU may report the indicated transmission power to the network; otherwise, if it is a WTRU-based positioning method, the WTRU may not report the indicated transmission power to the network.

Embodiments for performing closed-loop power control (CLPC) on a sidelink are now described. In one example the WTRU may indicate the information and request the feedback for a SL-PRS reception power. For example, the WTRU may perform a SL-PRS transmission. The WTRU may implicitly/explicitly request the receiver WTRU(s) to feedback the SL-PRS reception quality or received power. The WTRU may also indicate the information to help the Rx WTRU to perform the feedback (e.g., the Tx WTRU may implicitly indicate the target SL-RSRP or SL-RSRP reception threshold in its transmission (e.g., in SCI, MAC CE, and/or PC5 RRC)). Specifically, the WTRU may indicate and/or request the Rx WTRU(s) to feedback one or any combination of the following: whether to feedback the SL-PRS reception power; whether the Rx WTRU needs additional SL-PRS transmission; whether the received power of a SL-PRS is smaller/larger than a threshold; whether the received power of a SL-PRS is smaller than a threshold; whether the received power of a SL-PRS is larger than a threshold; and/or the reception level of a SL-PRS.

In one example the Tx WTRU may indicate to the Rx WTRU whether to feedback the SL-PRS reception power. If the Tx WTRU enables the feedback of SL-PRS reception power, the Tx WTRU may expect to receive a feedback from the Rx WTRU. Otherwise, if the Tx WTRU disables the feedback for SL-PRS reception power, the Tx WTRU may not expect to receive the feedback from the Rx WTRU.

In one example the WTRU may indicate to the RX WTRU whether the Rx WTRU needs additional SL-PRS transmission. For example, the Tx WTRU may request the Rx WTRU to feedback to itself whether the Rx WTRU needs more SL-PRS transmission within a period. In one approach, the Tx WTRU may indicate/configure the Rx WTRU to perform a minimum and/or maximum reception/measurement in N SL-PRS resources. In another approach, the Tx WTRU may (pre-)configure/indicate the Rx WTRU to perform a minimum and/or maximum reception/measurement of N SL-PRS resources, in which each SL-PRS resource should have measured SL-RSRP being greater than a threshold. The number of SL-PRS measurement resource and the threshold may be indicated to the WTRU (e.g., via sidelink positioning configuration, and/or via the transmission associated with SL-PRS) and/or (pre-)configured. The WTRU (e.g., Rx WTRU) may then determine whether to indicate that it has measured enough resource for SL-PRS measurement reporting. Specifically, if the number of measured resources having SL-RSRP being smaller than a threshold, the WTRU may request the Tx WTRU to perform additional SL-PRS transmission; otherwise, the WTRU may not request the Tx WTRU to perform additional SL-PRS transmission.

In one example the Tx WTRU may indicate to the Rx WTRU whether the received power of SL-PRS is smaller/larger than a threshold (e.g., an ACK/NACK based approach). For example, the Tx WTRU may request the Rx WTRU to feedback to the Tx WTRU whether the received power of an SL-PRS is larger or smaller than a threshold. The threshold may be (pre-)configured or may be indicated to the Rx WTRU by the Tx WTRU.

In another example the Tx WTRU may indicate to the Rx WTRU whether the received power of an SL-PRS is smaller than a threshold (NACK-based approach). For example, the Tx WTRU may request the Rx WTRU to feedback to the Tx WTRU whether the received power of an SL-PRS is smaller than a threshold. The threshold may be (pre-)configured or may be indicated to the WTRU. The Rx WTRU may feedback to the Tx WTRU if the received power of SL-PRS is smaller than the threshold; otherwise, the Rx WTRU may not feedback the reception power of the SL-PRS.

In some cases the Tx WTRU may indicate to the Rx WTRU whether the received power of SL-PRS is larger than a threshold (ACK-based approach). For example, the Tx WTRU may request the Rx WTRU to feedback to the Tx WTRU whether the received power of a SL-PRS is larger than a threshold. The threshold may be (pre-)configured or be indicated to the WTRU. The Rx WTRU may feedback to the Tx WTRU if the received power of a SL-PRS is larger than the threshold; otherwise, the Rx WTRU may not feedback the reception power of the SL-PRS.

In one example the WTRU may indicate to the Rx WTRU the reception level of a SL-PRS. For example, the Tx WTRU may request the Rx WTRU to feedback its reception power level of a SL-PRS. In one approach, the Rx WTRU may be (pre-)configured with a table of SL-RSRPs, in which each index of the table may be associated with one range of SL-RSRP. The Rx WTRU may then indicate the reception power level of a SL-PRS by indicating the index in the table.

In another example the WTRU may indicate to the Rx WTRU what type of feedback to provide for the reception power of a SL-PRS. The Tx WTRU may indicate to the Rx WTRU which type of feedback for the reception power of a SL-PRS (e.g., ACK-based, NACK-based, ACK/NACK-based, reception power level-based). The Rx WTRU may then feedback the reception power of an SL-PRS to the Tx WTRU based on the requested type of feedback from the Tx WTRU.

For some embodiments, the WTRU may indicate to the Rx WTRU the number of SL-PRS reception resources. For example, the Tx WTRU may indicate the maximum/minimum number of measured SL-PRS in a period. The Tx WTRU may expect the Rx WTRU to perform measurement in the number of resources within the indicated range. The minimum/maximum number of measured SL-PRS resources may be determined based on the QoS of the positioning service, the CBR of the resource pool, the measurement reporting period, and/or the SL-PRS pattern.

In another example the WTRU may indicate to the Rx WTRU the number of SL-PRS resources having an SL-RSRP being greater than a threshold. For example, the Tx WTRU may indicate the minimum number of the measured SL-PRS resources (e.g., N resources) in a period, in which the received power of each SL-PRS is greater than an indicated/(pre-)configured threshold. The value of N may be determined based on the QoS of the positioning service, the CBR of the resource pool, the measurement reporting period, and/or the SL-PRS pattern.

The WTRU may also indicate to the Rx WTRU the QoS associated with the feedback of SL-PRS reception power. The QoS may include the priority, latency, and/or reliability of the feedback message/signal.

In certain embodiments, the WTRU may use PSFCH, SCI, MAC CE, PC5 RRC, and/or NAS (e.g., LPP) message to feedback the reception power of SL-PRS to the Tx WTRU. The WTRU may use PSFCH to indicate whether it needs more SL-PRS reception resource to perform measurement. The WTRU may use PSFCH to indicate the whether the reception power is smaller/larger (e.g., ACK/NACK based approach) than a threshold. The WTRU may use SCI (e.g., second stage SCI) and/or MAC CE to indicate the reception level of the SL-PRS. In one approach, the WTRU may indicate the L3 filtered SL-RSRP of SL-PRS measurement from a set of SL-PRS resources. In another approach, the Rx WTRU may indicate multiple received L1 SL-RSRP, in which each SL-RSRP is associated with one SL-PRS resource.

In another example, the WTRU may determine the resource to feedback the reception power to the Tx WTRU. The WTRU (e.g., Rx WTRU) may determine the resource to feedback the reception power to the Tx WTRU. The resource to feedback the reception power of the Tx WTRU may be determined based on the type of message used to feedback the reception power. In one example, if the WTRU uses PSFCH to feedback the reception power of PSFCH. The WTRU may be (pre-)configured a mapping between SL-PRS reception and feedback. The WTRU may then determine which PSFCH resource to feedback based on the received SL-PRS resource. In another example, if the Rx WTRU uses SCI, MAC CE, PC5 RRC, and/or NAS (e.g., LPP) message to feedback the reception power of SL-PRS, the resource may be indicated by the Tx WTRU. In another approach, the Rx WTRU may be (pre-)configured a resource to perform transmission of the feedback, which may be conveyed in data channel (e.g., PSCCH/PSSCH).

In some instances, the Rx WTRU may determine the QoS of the feedback message. In this case the Rx WTRU may use SCI, MAC CE, PC5 RRC, and/or NAS (e.g., LPP) messages to feedback the reception power to the Tx WTRU. The Rx WTRU may determine the QoS (e.g., priority, latency, reliability, and/or minimum communication range) of the feedback message based on one or any combination of the following: (Pre-)configured priority; the QoS of the positioning service; the QoS of the sidelink positioning measurement reporting; and or implicit/explicit indication from another node.

In an example the Rx WTRU may determine the QoS of the feedback message based on a preconfigured priority. For example, the Rx WTRU may be (pre-)configured a priority (e.g., the highest priority) associated with the SL-PRS. The Rx WTRU may then perform sensing and resource allocation for the feedback based on the (pre-)configured priority. The Rx WTRU may then indicate the priority of the feedback in the transmission. The Rx WTRU may then implicitly/explicitly indicate the identity of the message as for feedback the reception power of the SL-PRS.

In another example the Rx WTRU may determine the QoS of the feedback message based on the QoS of the positioning service. For example, the priority of the feedback message may be equal to the priority of the positioning service. The Rx WTRU may then perform sensing and resource allocation for the feedback based on the (pre-)configured priority. The Rx WTRU may then indicate the priority of the feedback in the transmission.

For one embodiment, the Rx WTRU may determine the QoS of the feedback message based on the QoS of the sidelink positioning measurement reporting. For example, the priority of the feedback message may be equal to the priority of the sidelink measurement reporting message. The Rx WTRU may then perform sensing and resource allocation for the feedback based on the (pre-)configured priority and indicate the priority of the feedback in the transmission.

In certain cases the Rx WTRU may determine the QoS of the feedback message based on implicit/explicit indication from another node (e.g., from the Tx WTRU).

In another example the Rx WTRU may perform SL-PRS measurements. For example, the Rx WTRU may perform SL-PRS measurement to perform SL-PRS measurement reporting and/or feedback the reception power of SL-PRS to another node. The Rx WTRU may include one SL-PRS measurement resource in the report if the measured SL-RSRP of the resource is greater than a threshold. Otherwise, it may remove the measured resource from the reporting (e.g., the Rx WTRU may not include the resource in the filtering calculation and/or the Rx WTRU may not report the resource in the sidelink measurement report). In a certain period, the Rx WTRU may continue to perform measurement until it collects at least N resources having SL-RSRP being greater than a threshold. The value of N and the SL-RSRP threshold may be indicated from another WTRU (e.g., the Tx WTRU of SL-PRS).

For certain embodiments, the Tx WTRU may adapt its transmission power based on an indication from the Rx WTRU. In one approach, the Tx WTRU may adjust its transmission power based on the ACK/NACK-based feedback on SL-PRS reception power from the Rx WTRU. Specifically, the WTRU may keep the same power or decrease a power offset if it receives ACK from the Rx WTRU, which may be used to indicate that the reception power is greater than the threshold. Otherwise, the Tx WTRU may increase a power offset if it receives a NACK from the Rx WTRU, which may be used to indicate that the reception power is smaller than the threshold.

In another approach, the Tx WTRU may adjust its transmission power in accordance with a NACK-based feedback on SL-PRS reception power from the Rx WTRU. Specifically, the Tx WTRU may keep the same power if it does not receive feedback from the Rx WTRU; otherwise, the Tx WTRU may increase a power offset if it receives NACK from the Rx WTRU, which may be used to indicate that the reception power is smaller than the threshold.

In one embodiment, the Tx WTRU may adjust its transmission power in accordance with an ACK-based feedback of SL-PRS reception power from the Rx WTRU. Specifically, the Tx WTRU may increase its transmission power if it does not receive feedback from the Rx WTRU; otherwise, the WTRU may keep the same power if it receives ACK feedback from the Rx WTRU, which may be used to indicate that the reception power is larger than the threshold.

In another example, the Tx WTRU may adjust its transmission power based on the reported SL-PRS power reception level from the Rx WTRU. Specifically, the Tx WTRU may determine to increase/decrease a power offset based on the reported power reception level from the Rx WTRU. The power offset may be determined based on the QoS of the positioning service, and/or the CBR of the resource pool.

Embodiments for WTRU behavior if transmission reaches its (pre-)configured maximum power are now described. In one solution, the WTRU may perform one or any combination of the actions if its transmission power reaches its maximum and/or the number of SL-PRS transmissions reaches its maximum. The following behavior may be performed based on the implicit/explicit feedback from the Rx WTRU, which may implicitly/explicitly indicate the reception power of a received SL-PRS is smaller than the threshold. In one approach, the Tx WTRU may change the SL-PRS pattern (e.g., increase the comb-size, reduce the bandwidth). In another approach, the Tx WTRU may send the indication of transmission power to another node (e.g., another WTRU or gNB). In another approach, the WTRU may change the resource pool. In yet another approach, the WTRU may update group sidelink positioning by removing the Rx WTRU from the group. For example, the Tx WTRU is not able to raise the Tx power further (e.g., capped by the maximum Tx power) to increase the RSRP at Rx WTRU to clear the threshold, e.g., the Rx WTRU is just moving too far away. In this case, the Tx WTRU may decide to drop this Rx WTRU from the positioning group.

In a case where the Rx WTRU uses the PSFCH to feedback for a received SL-PRS, the Rx WTRU may determine the QoS (e.g., priority) of the feedback message based on one or any combination of the following: (Pre-)configured; the QoS (e.g., priority) of the SL-PRS; or the QoS (e.g., priority) of the SL-PRS measurement reporting.

In some scenarios, a WTRU may need to transmit and/or receive multiple PSFCHs, in which the PSFCH may be associated with SL-PRS feedback, inter WTRU coordination (IUC) for conflict indication, and/or sidelink data. The WTRU may then perform PSFCH prioritization if it is not able to transmit and/or receive simultaneously all required PSFCHs. The WTRU may perform PSFCH prioritization based on one or any combination of the following: pre-configured, For example, the WTRU may be (pre-)configured to sequentially prioritize one type of PSFCH over another type of PSFCH. For example, the WTRU may be (pre-)configured to prioritize PSFCH for data transmission first, the WTRU may then prioritize PSFCH for IUC second, and finally, the PSFCH has the lowest priority. The WTRU may then sequentially drop a PSFCH for an SL-PRS first, then it may drop PSFCH feedback for IUC, and finally, PSFCH for data communication is dropped last.

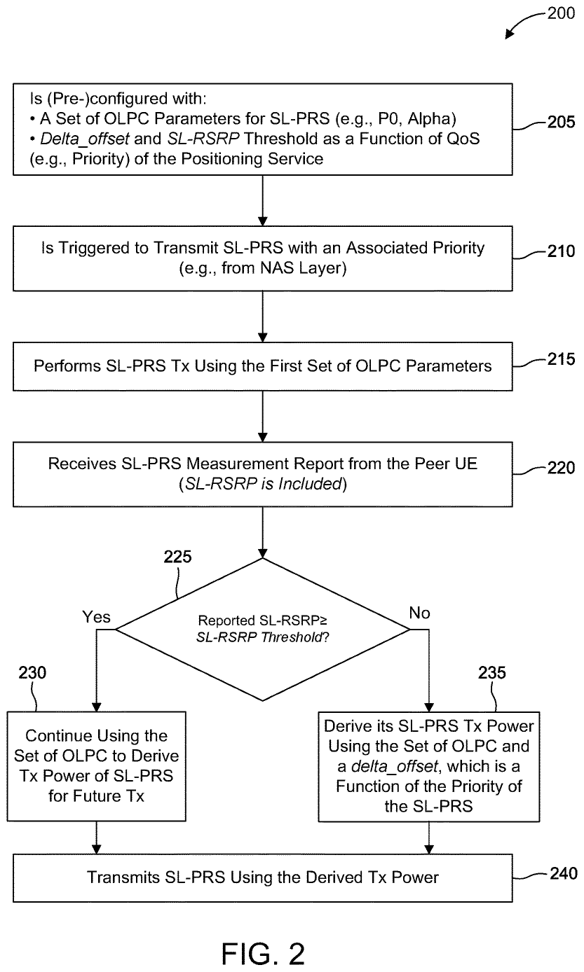

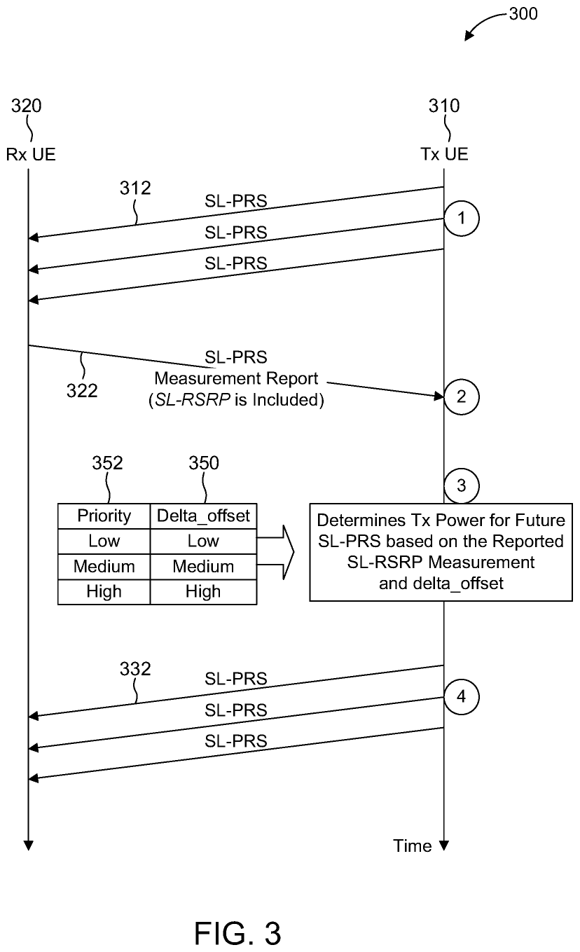

Referring to FIGS. 2 and 3, another example embodiment for a WTRU performing open loop power control (OLPC) is described herein. FIG. 2 shows an example OLPC method 200 for transmitting sidelink positioning reference signals (SL-PRSs). FIG. 3 shows a corresponding signaling diagram 300 for OLPC transmission and feedback of SL-PRSs between a Tx WTRU 310 and an Rx WTRU 320. In this example embodiment, a WTRU may determine whether to apply a power offset as a function of the QoS of the positioning service in an open loop power control (OLPC) formula for SL-PRS transmission and the reported SL-RSRP of the SL-PRS is smaller than a threshold. Specifically, the WTRU may perform the following procedure to determine transmission power of one or more SL-PRSs.

As shown in FIG. 2, method 200, the WTRU may be (pre-)configured 205 with the following OLPC power control parameters: SL and DL pathloss compensation (e.g. alpha and P0 for SL and DL); one or more SL-RSRP threshold(s), each associated with QoS (e.g., priority) of the positioning service; and one or more offset(s) for the OLPC formula, each offset as a function of QoS (e.g., priority) of the positioning service, referred to as a “delta_offset.” At 210, the WTRU may be triggered, e.g., by network access stratum (NAS) signaling, to transmit one or more SL-PRSs with an associated QoS/priority level. Next, the WTRU performs SL-PRS transmission 215 using the (pre-)configured OLPC based on the SL and DL pathloss compensation for the associated priority. At step 220, the WTRU receives sidelink positioning measurement reporting including an SL-RSRP from one or more peer Rx WTRU(s).

The WTRU compares 225 the received SL-RSRP to determine a power for a next SL-PRS transmission. If 230 the reported SL-RSRP is greater than the (pre-)configured SL-RSRP threshold for the associated QoS/priority, the WTRU uses the same OLPC formula with SL and DL pathloss compensation parameters to derive a transmission power for the next SL-PRS. Otherwise, at step 235, the WTRU increases the SL-PRS transmission power parameters by applying the (pre-)configured delta_offset, which is based on the priority/QoS of the positioning service, to the OLPC formula. At step 240, the WTRU transmits a next SL-PRS based on the power level derived at step 230 or 235. In some embodiments (not shown), if the Tx power reaches its maximum, the WTRU may perform one or any of: changing the SL-PRS pattern (e.g., increase comb size); changing the resource pool; and/or inform another node (e.g., gNB or another WTRU).

FIG. 3 shows an example signaling diagram 300 corresponding to method 200 of FIG. 2. As shown, in a first step, the Tx WTRU 310 transmits one or more SL-PRSs 312 with an associated QoS/priority level to the Rx WTRU 320 based on the (pre-)configured OLPC formula, including SL and/or DL pathloss parameters (alpha and P0). At a second step, the Rx WTRU 320 returns an SL-PRS measurement report 322 including a RSRP indication of the received SL-PRS(s). At a third step, Tx WTRU 310 evaluates the received RSRP feedback for determining a transmission power of a next SL-PRS to be transmitted. If the received RSRP is greater than or equal to a (pre-)configured threshold relating to the QoS/priority, then the Tx WTRU 310 will continue to use the original OLPC parameters to derive the power in transmitting additional SL-PRSs 332. If the received RSRP is below the (pre-)configured RSRP threshold for the associated QoS/priority, Tx WTRU 310 will additionally apply a delta_offset according to the (pre-)configured delta_offset 350 of the corresponding priority level 352. One or more additional SL-PRS(s) 332 may be transmitted by Tx WTRU 310 at a power based on the previous determination.

An example embodiment for a Tx WTRU performing closed loop power control (CLPC) is described herein. The Tx WTRU may perform CLPC for SL-PRS transmission and determine to adapt its SL-PRS transmission power based on the SL-RSRP threshold of the SL-PRS, the number of SL-PRS measurement resources, and the SL-PRS feedback from the receiver WTRUs. Specifically, the Tx WTRU may perform the following procedure to determine SL-PRS transmission power. First a WTRU is (Pre-)configured with the following parameters: the received SL-RSRP threshold of the SL-PRS and the number of SL-PRS measurement resources, which has received SL-RSRP being greater than the threshold, and an offset for each power adjustment step. Next the Tx WTRU performs a SL-PRS transmission and indicates the RSRP threshold to the Rx WTRU(s) (e.g., in the SCI associated with SL-PRS transmission) using an initial Tx power. Then the Tx WTRU receives feedback regarding SL-PRS reception power from Rx WTRU(s). Next the Tx WTRU performs the following for a new SL-PRS transmission: if the Rx WTRU(s) indicate the received SL-RSRP is smaller than the threshold, the Tx WTRU increases power using the (pre-)configured offset. Otherwise, the Tx WTRU uses the same Tx power for the new SL-PRS transmission and transmits one or more additional SL-PRS(s) using the determined power.

An example embodiment for a Rx WTRU performing closed loop power control (CLPC) is described herein. The Rx WTRU may perform CLPC for SL-PRS. The Rx WTRU may determine whether to include the received SL-PRS to the measurement report based on the received SL-RSRP of the SL-PRS. In the case that the received SL-RSRP is smaller than a threshold, the Rx WTRU feedbacks the SL-PRS reception power the Tx WTRU indicating the SL-RSRP is smaller than the threshold (e.g., one bit indication using the PSFCH). Specifically, the Rx WTRU may perform the following procedure for CLPC for SL-PRS reception. A WTRU may be (Pre-)configured with the number of SL-PRS measurement resources, which has received SL-RSRP being greater than a threshold. The Rx WTRU receives an SL-PRS from the Tx WTRU having RSRP threshold (e.g., an index in a RSRP threshold table) indicated in the associated SCI. If the SL-RSRP measured on the SL-PRS is smaller than the threshold, the Rx WTRU indicates to the Tx WTRU (e.g., a one bit indication using the PSFCH). Otherwise, the Rx WTRU includes the SL-PRS resources in the measurement report until the number of the measured of SL-PRS resources, which has SL-RSRP is greater than the SL-RSRP threshold, is greater than the threshold. Finally, the WTRU performs a SL-PRS measurement report and transmit it to the Tx WTRU.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

1. A method for a wireless transmit receive unit (WTRU), the method comprising:
receiving, from a peer WTRU, a sidelink reference signal received power (SL-RSRP) measurement report based on the peer WTRU's measurement of a previous transmission to the peer WTRU of at least one of a sidelink positioning reference signal (SL-PRS) or sidelink (SL) data;
determining to transmit a new SL-PRS at a transmission power based on a type of resource pool used for transmitting the new SL-PRS, wherein a first transmission power is selected if the type of resource pool is a shared pool and a second transmission power is selected if the type of resource pool is a dedicated pool; and
transmitting to the peer WTRU, the new SL-PRS using the selected first transmission power or the selected second transmission power.

2. The method of claim 1, wherein the first transmission power is based on the received SL-RSRP measurement report for previous transmission of SL data.

3. The method of claim 1, wherein the second transmission power is based on the SL-RSRP measurement report for previous transmission of the SL.

4. The method of claim 1, wherein the shared pool comprises time and frequency resources shared for SL-PRS transmission and SL data transmission.

5. The method of claim 1, wherein the dedicated pool comprises time and frequency resources only for SL-PRS transmission.

6. The method of claim 1, wherein prior to receiving the SL-RSRP measurement report, the method further comprises:
receiving configuration information indicating the resource pool to transmit the new SL-PRS as the shared pool or the dedicated pool.

7. (canceled)

8. A wireless transmit receive unit (WTRU) comprising:
a processor; and
a transceiver communicatively coupled to the processor; wherein the processor and the
transceiver are configured to:
receive, from a peer WTRU, a sidelink reference signal received power (SL-RSRP) measurement report based on the peer WTRU's measurement of a previous transmission to the peer WTRU of at least one of a sidelink positioning reference signal (SL-PRS) or sidelink (SL) data;
determine to transmit a new SL-PRS at a transmission power based on a type of resource pool used for transmitting the new SL-PRS, wherein a first transmission power is selected if the type of resource pool is a shared pool and a second transmission power is selected if the type of resource pool is a dedicated pool; and
transmit, to the peer WTRU, the new SL-PRS using the selected first transmission power or the selected second transmission power.

9. The WTRU of claim 8, wherein the first transmission power is based on the received SL-RSRP measurement report for previous transmission of SL data.

10. The WTRU of claim 8, wherein the second transmission power is based on the SL-RSRP measurement report for previous transmission of the SL-PRS.

11. The WTRU of claim 8, wherein the shared pool comprises time and frequency resources shared for SL-PRS transmission and SL data transmission.

12. The WTRU of claim 8, wherein the dedicated pool comprises time and frequency resources only for SL-PRS transmission.

13. The WTRU of claim 8, wherein prior to receiving the SL-RSRP measurement report, the processor and the transceiver are further configured to:
receive configuration information indicating the resource pool to transmit the new SL-PRS as the shared pool or the dedicated pool.

14. (canceled)

15. A method for a wireless transmit receive unit (WTRU), the method comprising:
receiving, from a peer WTRU, at least one of a first sidelink positioning reference signal (SL-PRS) or a sidelink (SL) data transmission;
determining to measure a sidelink reference signal received power (SL-RSRP) of the received first SL-PRS or the SL data transmission based on a type of resource pool used for transmission being a shared SL data and SL-PRS resource pool or a dedicated SL-PRS resource pool,
measuring the SL-RSRP of the received first SL-PRS or the SL data based on the type of resource pool used; and
sending, to the peer WTRU, a SL-RSRP measurement report indicating the measured SL-RSRP.

16. The method of claim 15, further comprising:
receiving, from the peer WTRU, a second SL-PRS at a transmission power based on the SL-RSRP measurement report.

17. The method of claim 15, wherein the shared SL data and SL-PRS resource pool comprises time and frequency resources for multiplexing SL-PRS with SL data.

18. The method of claim 15, wherein the dedicated SL-PRS resource pool comprises time and frequency resources only for SL-PRS transmission.
